(19) United States
(12) Patent Application Publication
(10) Pub. No.: US 2011/0316930 A1
(43) Pub. Date: Dec. 29, 2011

(54) MODULAR MICRO-FLUID EJECTION DEVICE

(76) Inventors: Richard E. Corley, Richomond, KY (US); Michael J. Dixon, Richmond, KY (US); Jiandong Fang, Lexington, KY (US); Jeanne Marie Saldanha Singh, Lexington, KY (US)

(21) Appl. No.: 12/825,851

(22) Filed: Jun. 29, 2010

(51) Int. Cl. B41J 2/145; B21D 53/76

(52) U.S. Cl. 347/40; 29/890.1

(57) ABSTRACT

A modular micro-fluid ejection device includes a carrier frame supporting pluralities of micro-fluid ejection modules. Each of the modules has a plate of nozzles defining a plane. Adjacent nozzle plates are substantially coplanar and registered with one another across the entirety of the carrier frame. Methods to mount the modules to the frame include, first, temporarily mounting one module and then another, and then permanently mounting both with a durable adhesive. Manufacturing systems include suction devices to hold a first module in place on a fixture while later modules are suctioned and registered to each other. Once set in place, a carrier frame is commonly contacted to the modules and the suction to released. Adhesives between the frame and modules cause the modules to separate from the fixture and transfer to the frame. All remain properly registered upon transfer.

### FIELD OF THE INVENTION

The present invention relates generally to micro-fluid ejection devices. Particularly, it relates to modular components and systems and methods for assembling same.

### BACKGROUND OF THE INVENTION

Conventional micro-fluid ejection devices, and more particularly ink jet printers, include a printhead carrier that carries one or more printheads. Such printheads have one or more local or remote fluid reservoirs in fluid communication with nozzles through which fluid exits the printhead toward a print medium. The nozzles are located on one or more ink jet chips.

The carrier is guided by one or more guide members, for example, a guide rod or tab. The guide members define a bi-directional path called the scanning direction. During printing, a controller directs the carrier to move in a reciprocating manner, back and forth along the guide members in the scanning direction. The movement transports the printhead(s) across the width of a print media as the media advances in a sub-scan direction orthogonal to the scanning direction. This allows the printhead(s) to eject fluid to image an entirety of the media.

When fashioning together multiple printheads, precise alignment on the carrier is critical for properly registering fluid drops on the media. Any skew from one printhead to the next manifests itself in poor image quality. In imaging devices having stationary printheads, such as those found in page-wide arrays, the problems are only exacerbated. Multiple aligned nozzle plates are required to cover the breadth of the media and each requires registration in the translational and rotational dimensions relative to every other plate. Precision during component manufacturing and alignment during assembly begins the registration process and early errors become compounded during later printing.

Accordingly, a need exists in the art for improving image quality where multiple printheads are used. The need extends not only to better controlling alignment and registration of printheads, but to manufacturing and assembly. Additional benefits and alternatives are also sought when devising solutions.

### SUMMARY OF THE INVENTION

The above-mentioned and other problems become solved with modular micro-fluid ejection devices. In a first embodiment, a carrier frame commonly mounts a plurality of ejection modules. Each module has a plate of nozzles defining a plane. Adjacent plates are substantially coplanar and registered with one another across an entirety of the frame. Print quality in lengthy arrays is improved. Representative mounting parameters contemplate less than about 0.20 degrees of rotation about the short and long in plane axes about the nozzle plate. In various designs, adjacent nozzle plates overlap one another on the frame or are spaced. Overlapped modules may include interlocking surfaces to facilitate placement. Nozzles of the plates may also align collinearly.

In other embodiments, each module fits within a thickness or rests on rails of the carrier frame. A first adhesive temporarily mounts an undersurface of a module ledge to a top of the frame. A second, more durable adhesive permanently mounts the modules to an inner surface of the thickness or rails. The first adhesive typifies epoxies or glues that can set or cure quickly to hold the precisely aligned modules temporarily in place. Curing of the first adhesive may include ultraviolet curing. Alternatives include thermal, infrared and microwave curing. The second adhesive typifies materials affording long term mechanical and functional stability. Dispensing the first adhesive occurs with limited physical exposure, such as in the form of discrete dots placed on particular frame surfaces. Dispensing the second adhesive occurs more liberally to multiple locations at a same time. In some embodiments, curing of the second adhesive occurs at room temperature.

Manufacturing systems include suction devices to hold a first module in place on a fixture while later modules are suctioned and registered to each other. A substantially planar surface of the fixture keeps modules aligned vertically, while horizontal adjustments occur manually or robotically. Once all are set in place, a carrier frame is commonly contacted to the modules and the suction released. After cure, the adhesives between the frame and modules cause the modules to separate from the fixture and transfer to the frame. All remain properly registered after the transfer. A pump supplies the suction and holes in the fixture fluidly connect to the pump. The pump selectively suctions individual modules onto the fixture. First and second adhesives are also contemplated to temporarily and permanently attach the modules to the frame. Portions of the fixture may be transparent to ultraviolet radiation. Alternatively, the fixture includes a window to pass radiation during curing.

In still further embodiments, the system includes spacers for mounting on the fixture member to contact individual modules. Each spacer has a substantially planar surface and a hole to align with one of the holes in the fixture member. Each spacer is configured to receive an adhesive on a side surface to mount the spacers to the fixture member. The spacers have a common thickness.

These and other embodiments will be set forth in the description below. Their advantages and features will become readily apparent to skilled artisans. The claims set forth their particular limitations.

### BRIEF DESCRIPTION OF THE DRAWINGS

The accompanying drawings incorporated in and forming a part of the specification, illustrate several aspects of the present invention. Together with the description, they serve to explain the principles of the invention. In the drawings:

FIG. 1 is a perspective view of a micro-fluid ejection module according to one embodiment of the present invention;

FIG. 2 is an exploded view of the micro-fluid ejection module of FIG. 1;

FIG. 3 is an exploded view of a plurality of micro-fluid ejection modules and a carrier frame;

FIG. 3a is a plan view of a plurality of micro-fluid ejection modules having horizontal skew relative to one another;

FIG. 3b is a diagrammatic view of micro-fluid ejection modules having misalignment relative to one another;

FIG. 3c is a side elevation view of a plurality of micro-fluid ejection modules having vertical skew relative to one another;

FIG. 3d is a diagrammatic view of micro-fluid ejection modules having misalignment relative to one another;

FIGS. 4 and 5 are diagrammatic views of adjacent micro-fluid ejection modules having overlapping nozzle plates;

FIGS. 6 and 7 are cross-sectional views of a micro-fluid ejection module temporarily and permanently mounted to a carrier frame, respectively;

FIG. 8 is a front elevation view of a plurality of micro-fluid ejection modules mounted to an alternate embodiment of a carrier frame;

FIG. 9 is a plan view of a plurality of overlapped micro-fluid ejection modules mounted to a carrier frame;

FIG. 10 is a perspective view of a fixture member having a plurality of spacers for mounting modules;

FIG. 11 is an exploded view of the fixture member and spacers of FIG. 10;

FIG. 12 is a cross-sectional view of a fixture member;

FIG. 13 is a first schematic view of a system for assembling a micro-fluid ejection device;

FIG. 14 is a second schematic view of the system of FIG. 13, including additional modules; and

FIG. 15 is a third schematic view of the system of FIG. 14, including a commonly mounted carrier frame.

### DETAILED DESCRIPTION

In the following detailed description, reference is made to the accompanying drawings. Like numerals represent like details. The embodiments enable those skilled in the art to practice the invention. Other embodiments may be utilized and process, electrical, and mechanical changes, etc., may be made without departing from the scope of the invention. The following is not to be taken in a limiting sense and the scope of the invention is defined only by the appended claims and their equivalents. In accordance with the present invention, methods and apparatus include modular micro-fluid ejection devices.

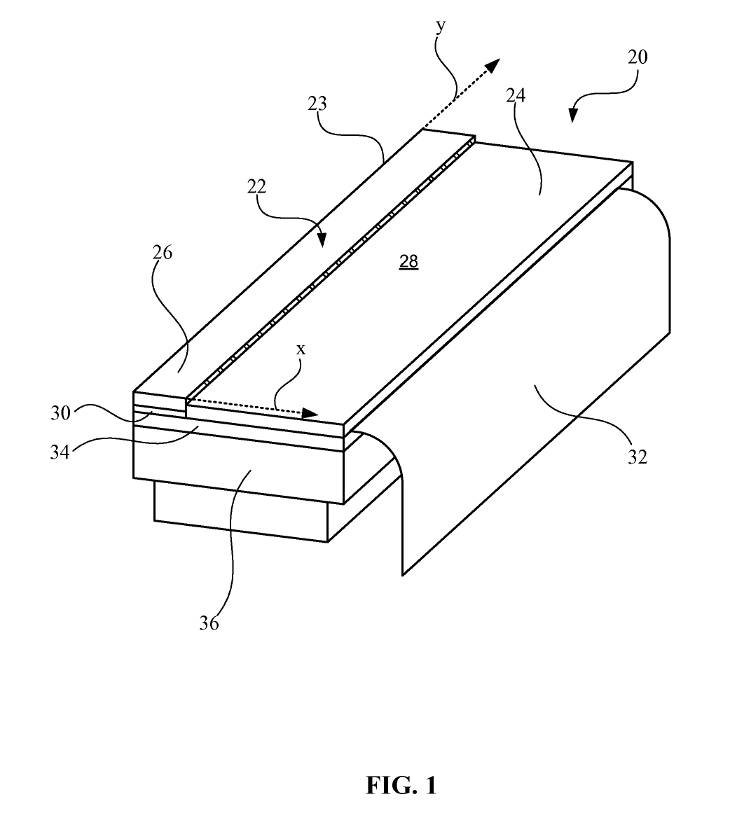

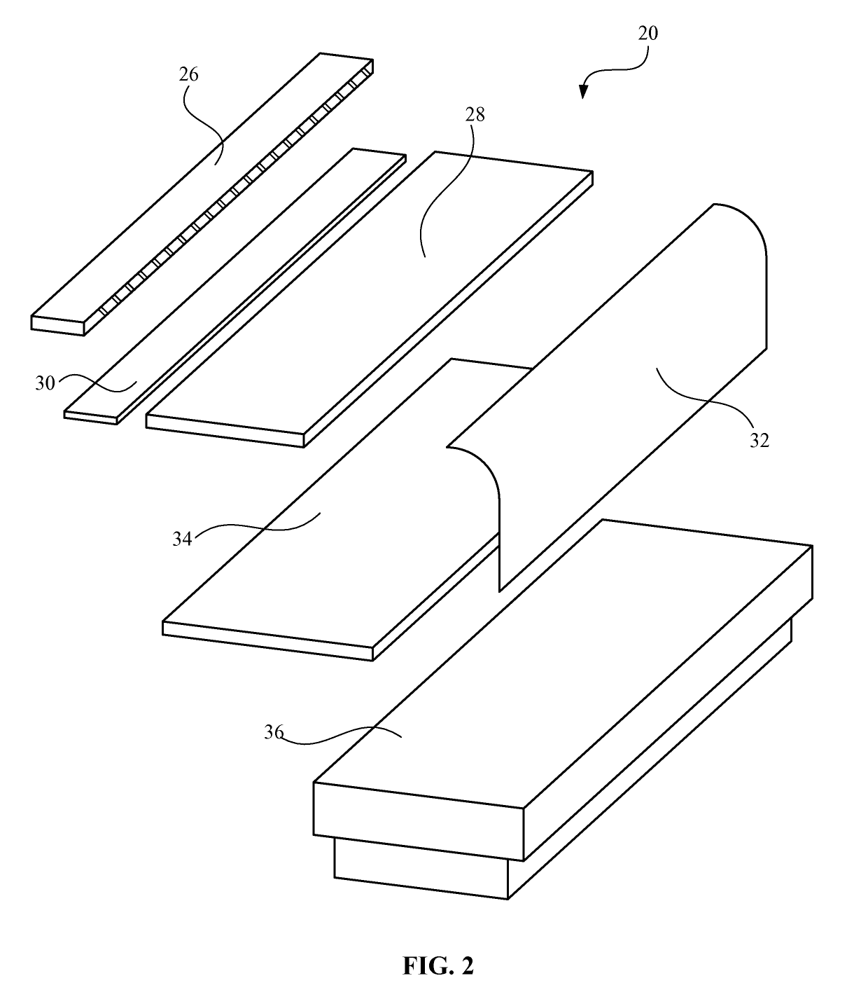

With reference to FIGS. 1 and 2, a micro-fluid ejection module 20 is shown. The module 20 may be a combination of parts forming a subassembly. The module 20 includes a nozzle plate 22 defining a plurality of nozzles for ejecting fluid. The nozzle plate defines a plane on at least a top side 24 of the module. The plane is defined by x and y axes. In some embodiments, the nozzle plate is located adjacent to a side edge 23 of the top side of the module. In others, it occupies an entirety of the top side or other portions thereof.

A module 20 typically includes a fluidic ejection device such as a heater chip 26 or a piezo ejection device. The chip resides beneath the nozzle plate and fluid firing elements cause fluid to eject through individual nozzles, as is known. The chip is formed as a series of thin film layers in combination with the nozzle plate or the plate independently attaches after formation of the chip. Also, modern designs contemplate fanning out fluidic connections downward from the chip through various manifolds. The fan-out includes one or more layers of silicon, ceramic, liquid crystal polymer, or the like. A printed circuit board (PCB) (such as a Stablcor brand carbon fiber laminate), along with flexible circuits are provided to make electrical connections to energize the firing elements during use. Wire or TAB bonds and associated encapsulants may also form part of the module 20 when completing the circuits. In the design shown, the module has a printed circuit board 28, a silicon manifold 30, a flex circuit 32, a silicon tile 34 and a ceramic base 36. The parts are attached or molded into the module 20 by conventional means to allow the module to eject fluid (e.g., ink) from a reservoir (not shown) toward a print medium. Also, the module may be designed in a fashion to operate as a heat sink to remove heat from the heater chip to allow for faster printing. Specific proposals illustrating fluidic fan-out can be found in the Applicant's co-pending U.S. patent applications (Ser. Nos. 12/624,078, filed Nov. 23, 2009, and 12/568,739, filed Sep. 29, 2009), both of which are incorporated herein by reference.

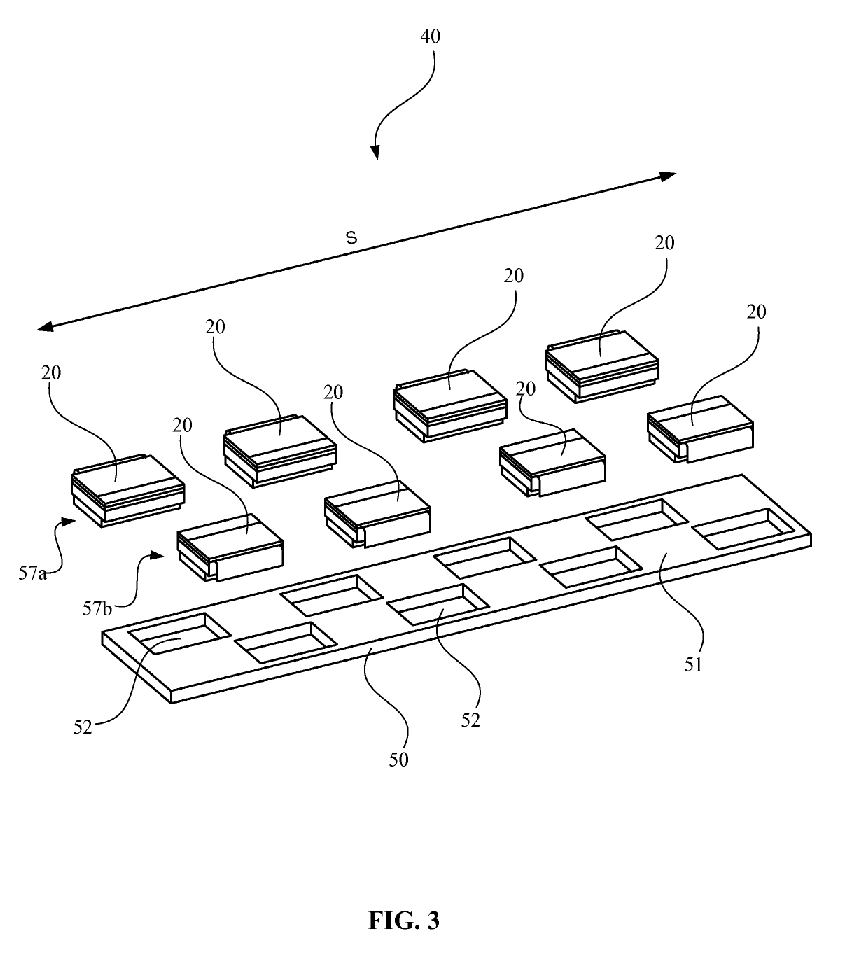

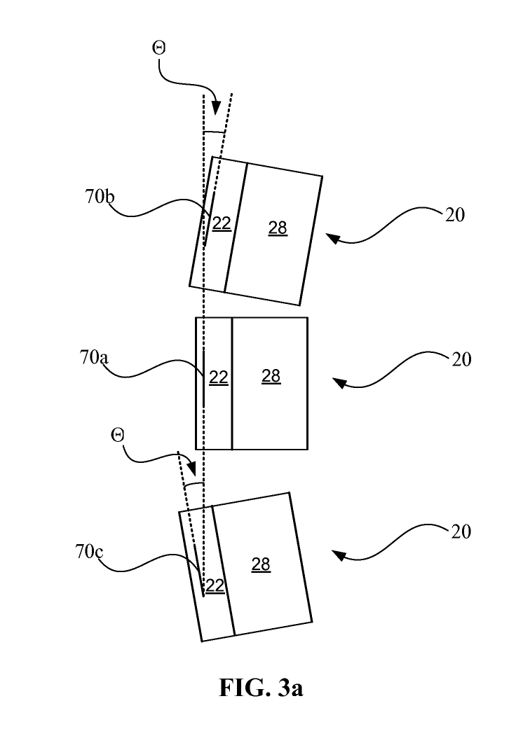

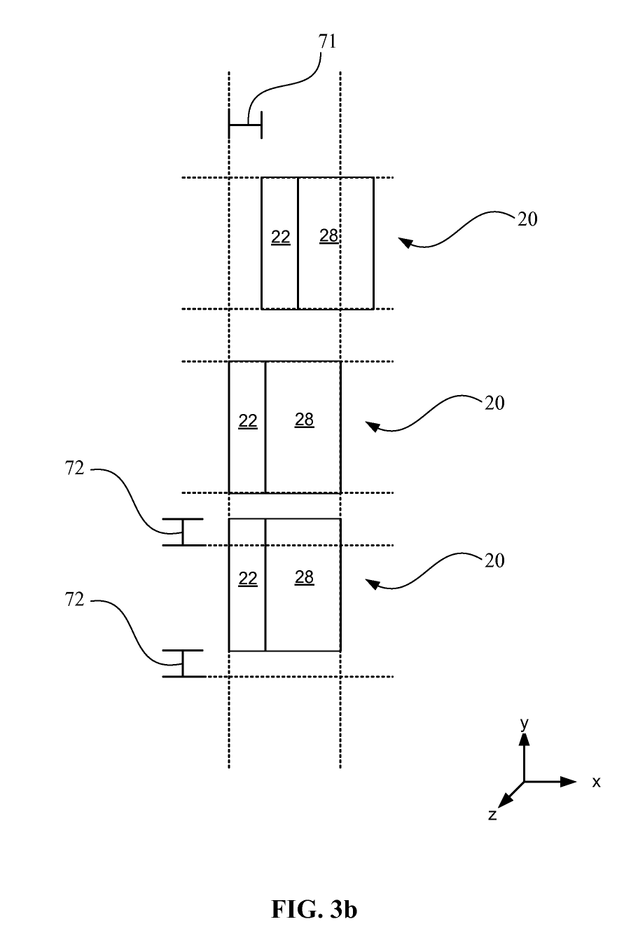

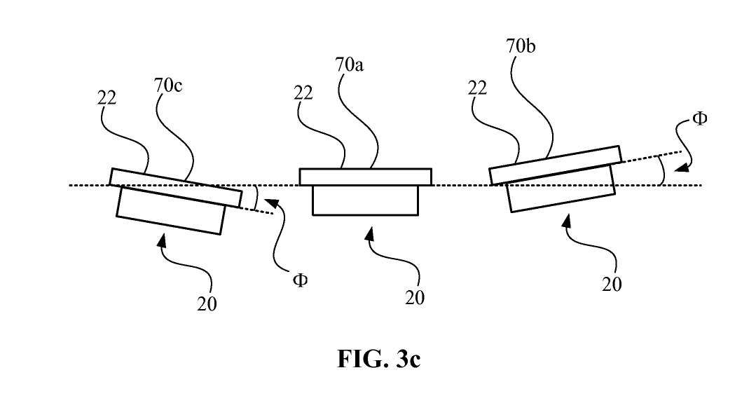

With reference to FIG. 3, a modular micro-fluid ejection device 40 is shown. The ejection device 40 includes a plurality of modules 20 commonly mounted to a carrier frame 50. Each module is registered and aligned with adjacent modules and printing is carried out by either scanning the frame past an advancing media or constructing the ejection zone of the modules wide enough to accommodate a width of the media. The design also permits individual placement of modules so that electrical and functional testing can occur prior to placement in the frame and/or replacement of singularly defective modules.

The carrier frame 50 is made substantially of metal, plastic or any other suitable material. Thermal properties, stiffness, weight and conductivity are a few of the considerations skilled artisans will recognize when selecting a material. In size, the modules form a layout that operationally extends at least as wide as a desired print medium. If a desired media for imaging is 8½ inches×11 inches, the fluid ejecting zone of the modules may span (S) at least 8½ inches across the frame or scan to this same distance. Alternatively, the span (S) may range from a few inches for use in the field of “coupon” or “receipt printers” to thirty six inches or more for printers involved in imaging banners or other lengthy substrates. Alternatively, the modules form a layout that is less than the width of a desired print medium and the ejection device moves bi-directionally in the scanning direction across the width of the print media.

In order to permit precise ejection of fluid from the ejection device, it is necessary to precisely locate the nozzle plates 22 of all modules in three dimensions. In some embodiments, the heights of the nozzle plates relative to a top of the frame are substantially the same such that each is substantially coplanar with one another (z-dimension). Further, the nozzle plates are registered with one another such that the x and y axes defined by each nozzle plate are substantially parallel with one another. The precise arrangement allows for optimal print quality.

With reference to FIGS. 3a-3d, the orientations for the nozzle plates of the modules are seen diagrammatically. In 3a, horizontal skew between the nozzle plate of one module and the nozzle plate of an adjacent module is given as a horizontal angle of misalignment Θ. The angle is controlled to be less than about 0.10 degrees and more particularly less than about 0.03 degrees. The angle is best seen by measuring the angle formed between a reference line of nozzles 70a in the nozzle plate of a first module and corresponding lines of nozzles 70b and 70c in adjacent nozzle plates.

With reference to FIG. 3b, misalignment between adjacent nozzle plates in the x-direction can be seen as an offset distance 71. Further, misalignment between adjacent nozzle plates in the y-direction can be seen as an offset distance 72. It is preferred that the modules are registered with one another such that the x and y axes defined by each nozzle plate are substantially parallel with one another and substantially no misalignment in the x or y directions exist. Less than 20 microns, and preferably less than 10 microns, of misalignment in the x or y directions exist. The proper alignment of the modules is further dictated by the desired separation or offset between adjacent modules. The offset distances can be measured from an edge of the top side of each module relative to a reference line indicating the proper alignment of the module, illustrated by the dashed lines in FIG. 3b.

With reference to FIG. 3c, adjacent modules may also possess misalignment in the form of vertical skew. In this situation, a vertical angle of misalignment Φ exists between the planarity of a nozzle plate and the planarity of a top of the carrier frame. The amount of skew is determined by measuring the angle Φ formed between a reference line extending from the top of the carrier frame (in cross-section) and a corresponding line extending from the nozzle plate (in cross-section). Appreciating that the carrier frame and nozzle plate may have different planarity at different cross-sectional slices, the vertical skew can be measured at a variety of locations and averaged together, or a mean taken, or other. In either event, it is preferred that less than about 0.20 degrees of vertical skew exist relative to one another and more particularly less than about 0.05 degrees.

With reference to FIG. 3d, misalignment between adjacent nozzle plates can be seen in the z-direction as an offset distance 73. It is preferred that adjacent modules are registered with one another such that the nozzle plates of adjacent modules are substantially coplanar and substantially no misalignment in the z-direction exists. The offset distance in the z-direction can be measured from corresponding portions, such as the nozzle plate or an undersurface of a module ledge, of adjacent modules.

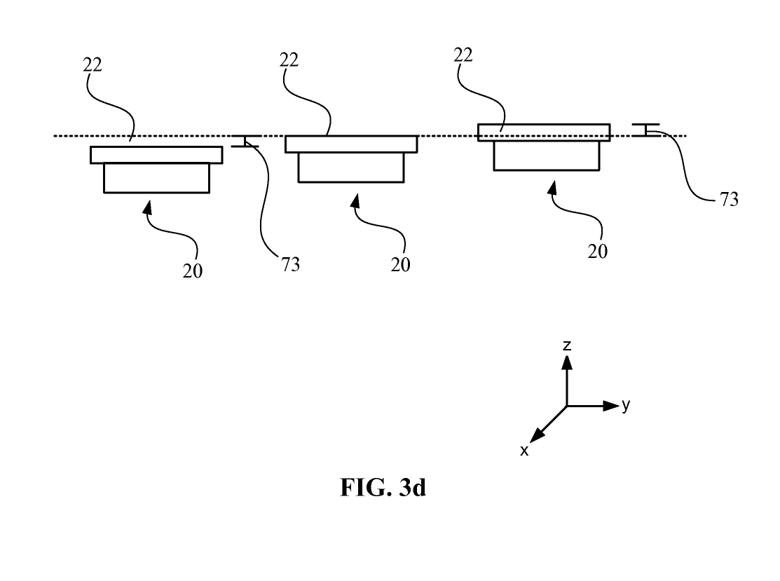

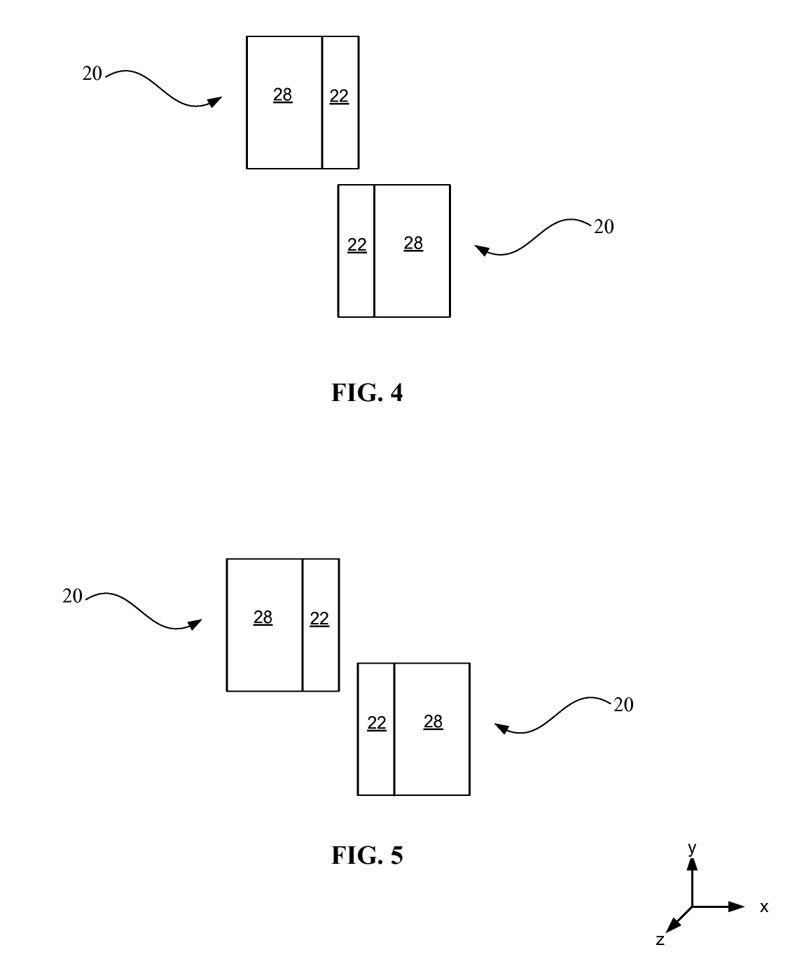

With reference to FIG. 4, adjacent modules are shown inverted 180 degrees relative to one another thereby minimizing the distance between adjacent nozzle plates. The nozzle plates of the adjacent modules overlap with one another in the y-direction. With reference to FIG. 5, an alternative embodiment is shown wherein adjacent nozzle plates overlap with one another in the x-direction.

Referring back to FIG. 3, a thickness of the carrier frame 50 defines a plurality of openings 52. Each module 20 mounts in one of the openings. Each opening typifies a through hole in the carrier frame or a mere recess having a bottom surface.

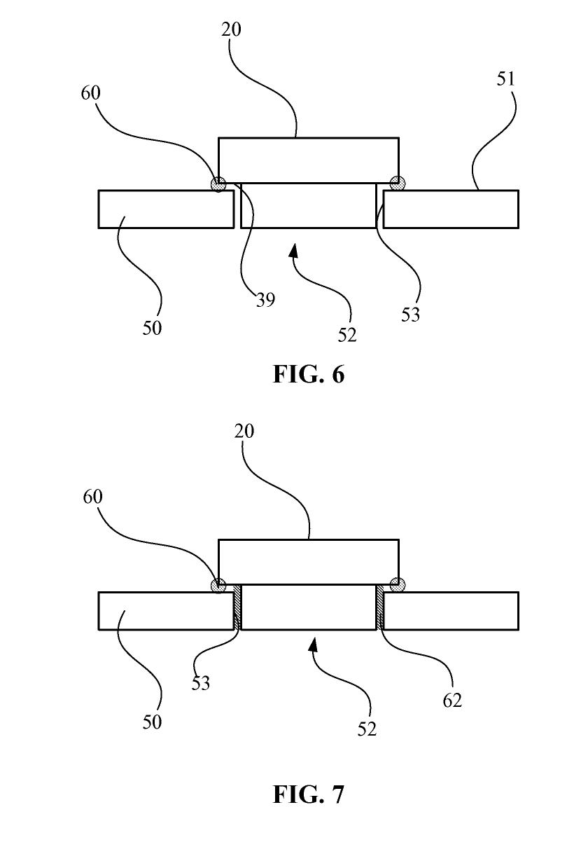

With reference to FIG. 6, a first adhesive 60 mounts the module to the carrier frame. The adhesive is disposed on a top side 51 of the carrier frame and an undersurface of a module ledge 39 to mate together the module and frame. Also, the first adhesive is dispensed in controllable amounts, such as discrete dots at predetermined locations on the frame, to momentarily tack the module and keep it from moving. The first adhesive is selected with properties allowing it to cure without substantially misaligning the orientation of the modules. Examples include, but are not limited to, EMCAST™ 1748S-HTG Series sold by EMIUV, Inc., Emerson and Cuming ECCOBOND™ LV4359-88, etc. Curing can involve UV curing. Alternatively, a fast cure adhesive is used such as, for example, cyanoacrylate adhesives or the like.

With reference to FIG. 7, a second adhesive 62 permanently mounts the modules to the carrier frame. In some embodiments, the second adhesive 62 is disposed on an inner surface 53 of the openings and on corresponding surfaces of the module. The second adhesive has properties that allow for long term mechanical stability of the modules, e.g., immovability. The second adhesive is selected to allow it to cure at room temperature. Curing at room temperature avoids thermal expansion that could result in bowing or movement of the modules relative to one another or the frame. The second adhesive is representatively a two part epoxy. Examples include, but are not limited to, 3M Scotch Weld DP 420, 3M Scotch Weld DP 460, etc. However, any suitable adhesive may be used, including any suitable curing temperature without distorting and/or misalignment.

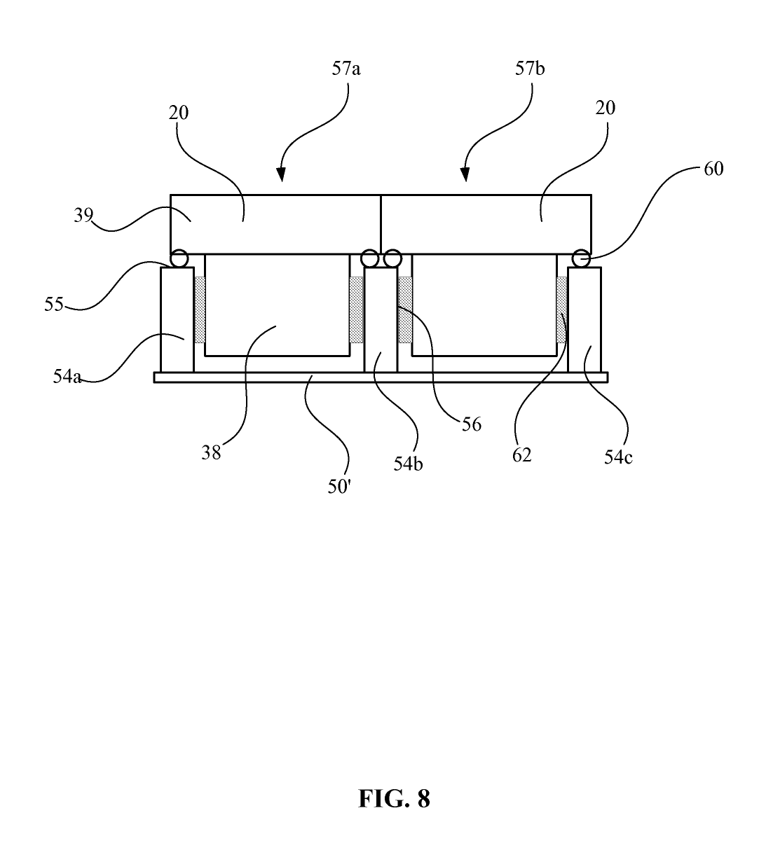

With reference to FIG. 8, an alternate embodiment of the carrier frame 50′ contemplates a plurality of rails 54a, 54b, and 54c. Each module 20 mounts to a top side 55 of the rails with a first adhesive and to inner surfaces 56 of the rails with a second adhesive. As before, the first adhesive momentarily tacks the modules in place while the second adhesive permanently affixes them from moving. Adhesives may also be used in a bottom of the carrier frame beneath the lower module portion 38. Appreciating this design includes two outer 54a, c, and one inner rail 54b, the modules will align in the frame in two adjacent rows across a width of a media. However, other designs appreciate that any suitable configuration of rows and rails may be used.

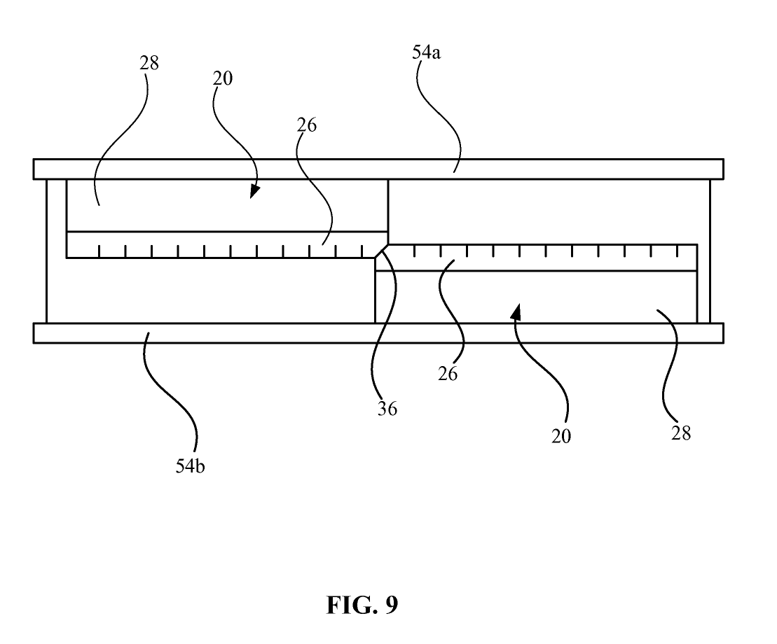

With reference to FIG. 9, embodiments include those wherein each module has an interlocking surface complementarily matable with an interlocking surface of an adjacent module. As envisioned, the two surfaces of separate modules combine to mutually supply the other module's lack. In this manner, alignment between adjacent modules can be improved, mechanical stability enhanced, or both. In the embodiment shown, the interlocking surface is located on a corner of each module and typifies slanted edges 36 of mutually compatible angles. Other features are possible. Complementary joints include mortise and tenon, rabbet and dado, lap joints, butt joints, or other. Mechanical fasteners and/or adhesives may also be added for strength.

In any of the foregoing, methods for assembling the ejection device of the present invention contemplate conventional assembly tools. In a representative situation, the carrier frame is loaded into a pick and place tool. A first of the ejection modules is then picked and mated with the frame. The pick tool comprises a vacuum chuck and/or robotic arms that contact the module in the vicinity where no nozzles of the nozzle plate are present. In some embodiments, the first ejection module is mated with an opening in the carrier frame. Alternatively, the module is mated on multiple rails. Alternatively still, the module is preconfigured with the first adhesive or the first adhesive is applied after the pick. The module is moved toward the carrier frame and placed face up (nozzles up) into the first adhesive. In some embodiments, the module is pressed into the thickness of the adhesive dot but not so far as to squeeze out the adhesive and cause contact with the carrier frame. This ensures that the maximum tolerance stack up is accounted for such that the height of each module on the carrier frame is the same. The first adhesive 60 is then cured, such as by applying ultraviolet radiation. The pick and place tool remains engaged with both the carrier frame and the first module during this time to maintain proper positional alignment. Similarly, a second module is temporarily cured in place on the carrier frame with the first adhesive. A second, durable adhesive is then applied to all the modules and/or frame to permanently affix them in place. The properties of the second adhesive allow a rigid interconnection between the modules and frame.

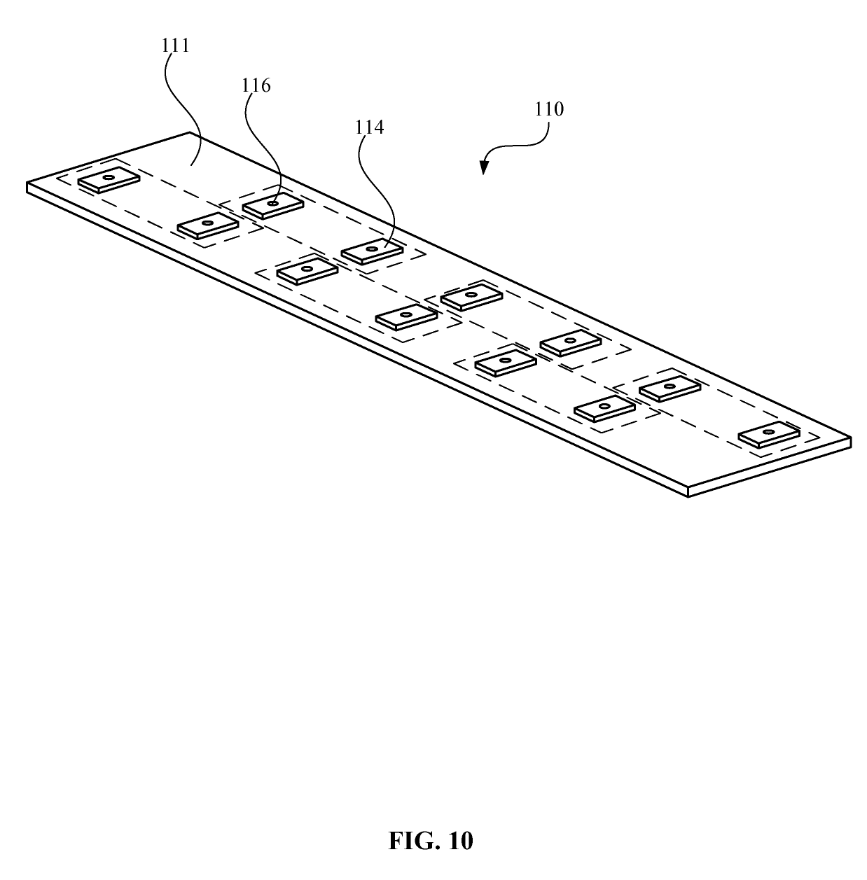

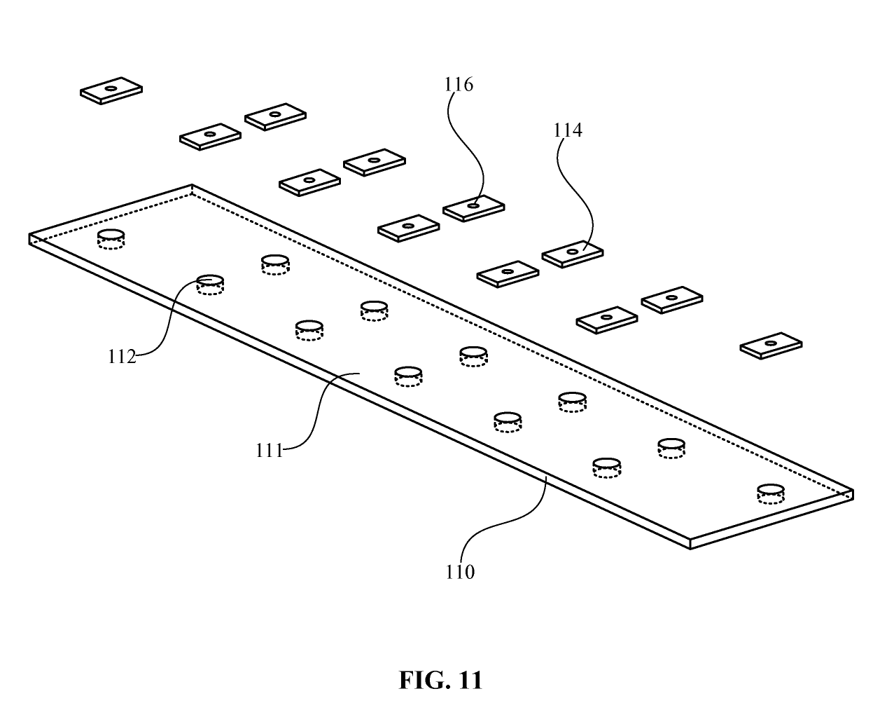

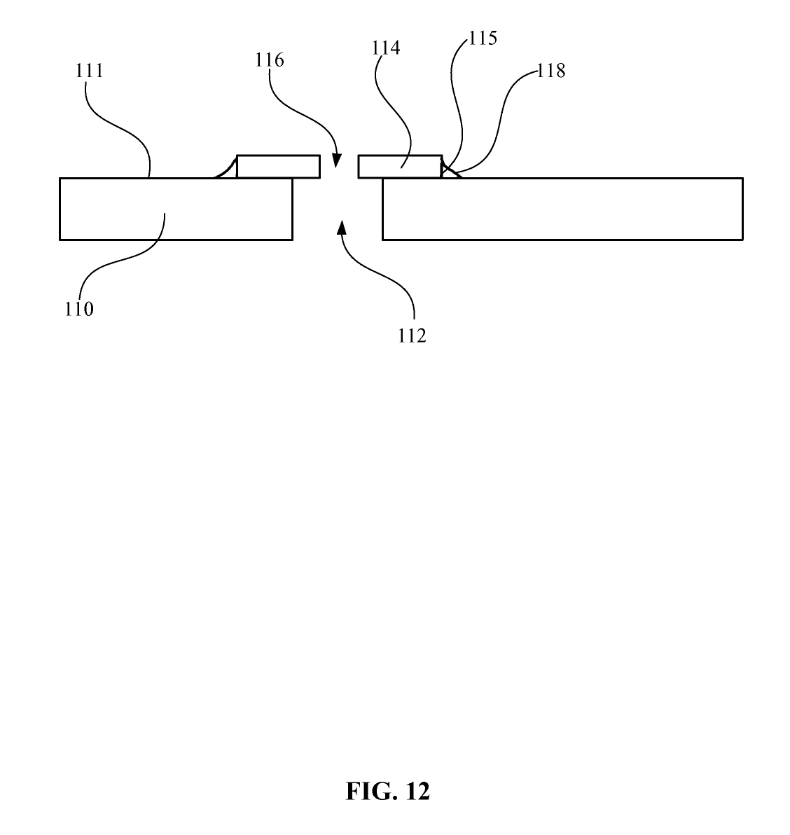

With reference to FIGS. 10-12, a system for assembling an ejection device includes a fixture member 110. The member has a substantially planar locating surface 111 and a plurality of through holes 112. The holes are configured to allow suction of ejection modules into a planar relationship on the surface 111 to temporarily hold them in place for later transfer to the carrier frame. In some embodiments, the holes 112 are arranged to permit two suction points between each module, as seen by the dashed lines in FIG. 10. Suction locations are generally selected such that they avoid the nozzle locations on the modules.

In some embodiments, the system further includes a plurality of spacers 114 for mounting on the fixture member 110. Each spacer 114 has a substantially planar surface and a hole 116 configured to fluidly align with one of the holes 112 in the fixture member. The holes 116 are configured to suction ejection modules to temporarily hold the modules in place against the spacers, while the planar surface keeps planar the nozzle plates of adjacent modules. In certain configurations, the holes 116 are approximately 0.5 mm in diameter. Their size takes into account the available area for suctioning the top side of each module without contacting the nozzles in the nozzle plate. It also considers the magnitude of the suction force to be applied in order to ensure that sufficient force is applied to hold the modules while also avoiding excessive force that could damage the module. In composition, the spacers typify silicon from a common wafer such that each has a precisely matched thickness to mount each module in a common plane. To keep each spacer on the fixture member, it is contemplated that an adhesive 118 will be applied to a side surface 115 of each spacer so that a height of each spacer above the fixture member will remain true to the thickness of the spacer. Alternatively, the spacers may be attached to the fixture member with a bondline on a backside surface and then co-polished together to a common height. Additional alternatives include those where, in place of spacers, portions of the surface of the fixture member adjacent to the suction locations are recessed to avoid contacting the nozzles of the modules. This may be accomplished by etching recessed areas into a fixture member comprised of photostructurable glass.

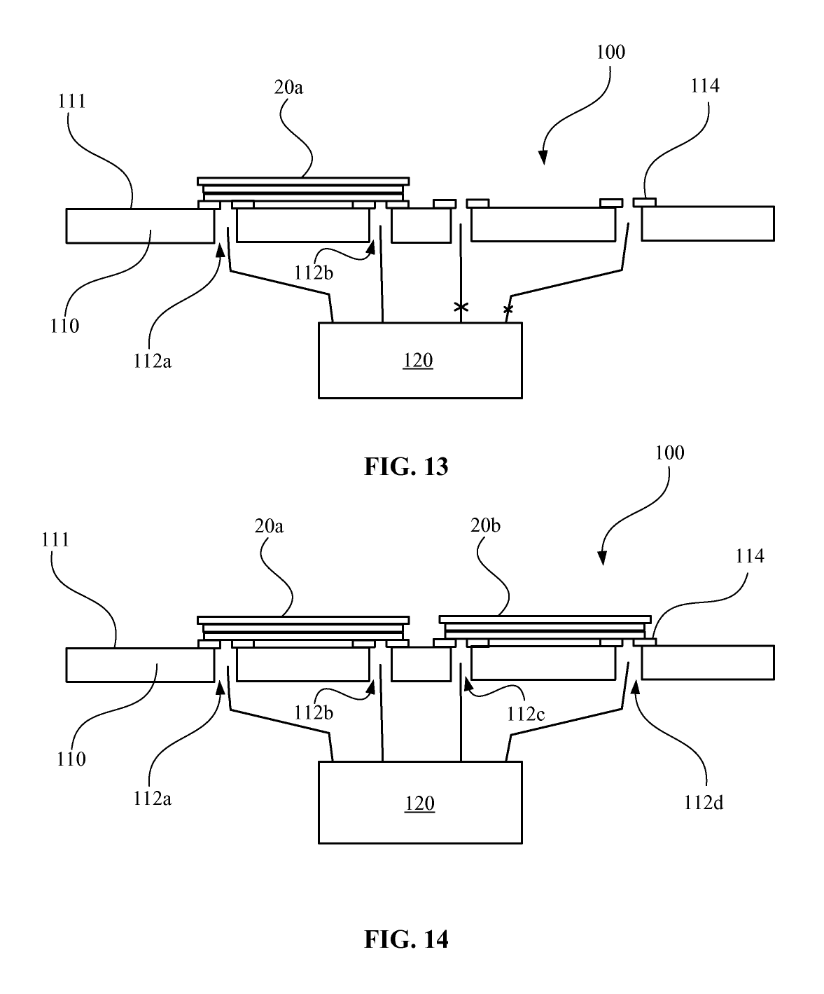

With reference to FIGS. 13-15, the assembly system further includes a pump 120. The pump 120 is configured to selectively apply suction through the holes 112 in the fixture member (and through spacer holes 116 if utilized) to individually hold discrete modules 20a, 20b. During use, a first module 20 is held in place against the surface 111 (or surface of the spacers 114), as in FIG. 13. The planarity of the surface keeps the nozzle plate correspondingly planar without vertical skew. It is manipulated manually or robotically to eliminate any horizontal skew or other misalignment. A second module 20b is then mated with the fixture and registered with the first module. The second module is suctioned to the fixture as seen in FIG. 14. Similarly, additional modules are suctioned and manipulated. Once set, an overall positional accuracy may be measured. Any modules not having acceptable alignment may optionally be repositioned.

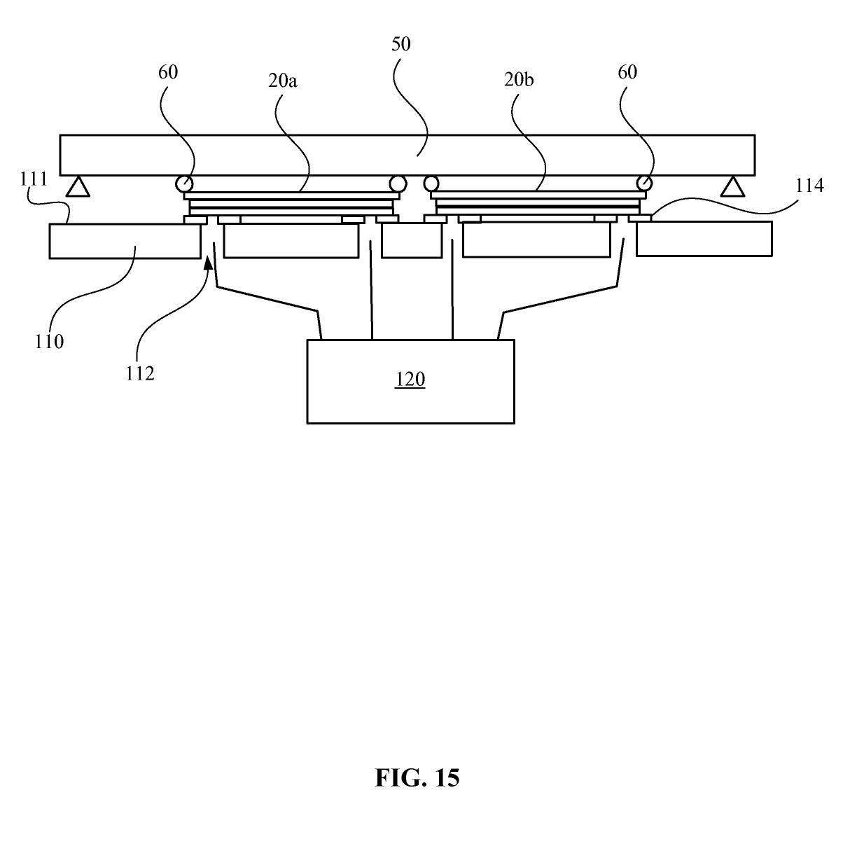

With reference to FIG. 15, the first adhesive 60 is applied to either the carrier frame 50 and/or to each module 20. It is applied such that it will not interfere with the nozzles defined by any nozzle plate. The modules 20a, 20b are then mated with the carrier frame 50. As before, this can include positioning in openings through a thickness of the frame or on rail tops. The first adhesive 60 is then cured. It is cured by applying ultraviolet radiation through radiation transparent portions of the fixture member or through windows disposed directly therein.

The fixture member is then separated from the ejection modules to transfer them to the carrier frame 50 with proper registration and planarity relative to one another. The use of a fixture member in this manner allows mating of all modules with the carrier frame at one time rather than one module at a time. Separating the ejection modules includes releasing the suction applied by the pump 120 and removing the fixture member. The modules 20 are then permanently adhered to the carrier frame 50 by application of the second adhesive 62. Alternatively, the application of the second adhesive can occur before separation of the fixture member. Alternatively still, the locating surface 111 of the fixture member can be oriented face down and the modules delivered face up, in contrast to the figures. In this way, the assembly system prevents dust from settling on the locating surface of the fixture member which may otherwise adversely affect the height and/or planarity of the modules.

The foregoing has been presented for purposes of illustrating the various aspects of the invention. It is not intended to be exhaustive or to limit the claims. Rather, it is chosen to provide the best illustration of the principles of the invention and its practical application to enable one of ordinary skill in the art to utilize the invention, including its various modifications that naturally follow. All such modifications and variations are contemplated within the scope of the invention as determined by the appended claims. Relatively apparent modifications include combining one or more features of various embodiments with one another.

1. A modular micro-fluid ejection device, comprising:
a carrier frame; and
a plurality of micro-fluid ejection modules each mounted to the carrier frame, each of the micro-fluid ejection modules having a nozzle plate defining pluralities of nozzles, the nozzle plate defining a plane,
wherein adjacent nozzle plates are substantially coplanar and registered with one another across the carrier frame.

2. The modular micro-fluid ejection device of claim 1, wherein adjacent nozzle plates overlap with one another.

3. The modular micro-fluid ejection device of claim 1, further including discrete dots of an adhesive connecting the modules to the carrier frame.

4. The modular micro-fluid ejection device of claim 1, wherein each micro-fluid ejection module has a first portion within a thickness of the carrier frame and a second portion on top of the carrier frame.

5. The modular micro-fluid ejection device of claim 1, wherein each micro-fluid ejection module mounts in one of a plurality of openings in the carrier frame.

6. The modular micro-fluid ejection device of claim 5, further including a first adhesive to mount the micro-fluid ejection modules on a top side of the carrier frame.

7. The modular micro-fluid ejection device of claim 6, further including a second adhesive to mount the micro-fluid ejection modules on an inner surface of the openings.

8. The modular micro-fluid ejection device of claim 1, wherein each micro-fluid ejection module mounts to a plurality of rails along the common carrier frame.

9. The modular micro-fluid ejection device of claim 8, further including a first adhesive to mount the micro-fluid ejection modules on a top side of the rails.

10. The modular micro-fluid ejection device of claim 9, further including a second adhesive to mount the micro-fluid ejection modules on an inner surface of the rails.

11. The modular micro-fluid ejection device of claim 1, wherein each micro-fluid ejection module has an interlocking surface matable with an interlocking surface of an adjacent micro-fluid ejection module.

12. The modular micro-fluid ejection device of claim 1, wherein adjacent micro-fluid ejection modules have less than about 0.10 degrees of horizontal skew relative to one another.

13. The modular micro-fluid ejection device of claim 1, wherein adjacent micro-fluid ejection modules have less than about 0.20 degrees of vertical skew relative to one another.

14. A method for assembling a modular micro-fluid ejection device, comprising:
providing a carrier frame to commonly mount a plurality of micro-fluid ejection modules;
mating a first of the ejection modules with the carrier frame;
temporarily adhering the first ejection module to the carrier frame with a first adhesive having properties allowing the first adhesive to cure without substantially expanding or contracting thereby avoiding substantially misaligning the mating of the first ejection module with the carrier frame; and
permanently adhering the first ejection module to the carrier frame with a second adhesive having properties allowing mechanical stability.

15. The method of claim 14, wherein the temporarily adhering the first ejection module to the carrier frame includes applying discrete dots of the first adhesive between the first ejection module and a top side of the carrier frame.

16. The method of claim 14, further including curing the first adhesive by applying ultraviolet radiation to the first adhesive.

17. The method of claim 14, wherein the mating the first ejection module with the carrier frame includes mating the first ejection module with an opening in the carrier frame.

18. The method of claim 17, wherein the permanently adhering the first ejection module to the carrier frame includes applying the second adhesive between the first ejection module and an inner surface of the opening.

19. The method of claim 14, wherein the mating the first ejection module with the carrier frame includes mating the first ejection module with a plurality of rails along the carrier frame.

20. The method of claim 19, wherein the permanently adhering the first ejection module to the carrier frame includes applying the second adhesive between the first ejection module and an inner surface of a first of the rails and applying the second adhesive between the first ejection module and an inner surface of a second of the rails.

21. The method of claim 14, further including:
mating a second of the ejection modules with the carrier frame;
manipulating the second ejection module so that the second ejection module is registered relative to the first ejection module and a nozzle plate of the first ejection module is substantially coplanar with a nozzle plate of the second ejection module;
temporarily adhering the second ejection module to the carrier frame with the first adhesive; and
permanently adhering the second ejection module to the carrier frame with the second adhesive.

22. The method of claim 21, further including manipulating the second ejection module so that the nozzle plate of the second ejection module overlaps with the nozzle plate of the first ejection module.

23. A method for assembling a modular micro-fluid ejection device, comprising:
providing a fixture member having a substantially planar surface, the fixture member being configured to temporarily hold a plurality of micro-fluid ejection modules;
providing a carrier frame to commonly mount the ejection modules;
suctioning a first of the ejection modules to the fixture member in a desired orientation on the fixture member;
suctioning a second of the ejection modules to the fixture member so that the second ejection module is registered relative to the first ejection module and a nozzle plate of the first ejection module is substantially coplanar with a nozzle plate of the second ejection module;
mating the ejection modules with the carrier frame; and
separating the fixture member from the ejection modules to transfer the ejection modules to the carrier frame with proper registration and planarity relative to one another.

24. The method of claim 23, further including adhering the ejection modules to the carrier frame with a first adhesive having properties allowing the first adhesive to cure without substantially expanding or contracting.

25. The method of claim 24, further including applying discrete dots of the first adhesive in predetermined positions on a top side of the carrier frame.

26. The method of claim 24, further including curing the first adhesive without substantially misaligning the mating of the ejection modules with the carrier frame.

27. The method of claim 26, wherein curing the first adhesive includes applying ultraviolet radiation to the first adhesive through a transparent portion of the fixture member.

28. The method of claim 23, wherein separating the fixture member from the ejection modules includes releasing the suction.

29. The method of claim 23, further including permanently adhering the ejection modules to the carrier frame with a second adhesive having properties allowing mechanical stability.

30. The method of claim 23, wherein the mating the ejection modules with the carrier frame includes mating each ejection module with an opening in the carrier frame.

31. The method of claim 23, wherein the mating the ejection modules with the carrier frame includes mating each ejection module with a plurality of rails along the carrier frame.

32. The method of claim 23, further including suctioning at least one of the first ejection module and the second ejection module so that the nozzle plate of the second ejection module overlaps with the nozzle plate of the first ejection module.

33. The method of claim 23, further including suctioning additional ejection modules to the fixture member until a desired number of ejection modules are achieved.

34. A system for assembling a modular micro-fluid ejection device, comprising:
a pump; and
a fixture member fluidly connected to the pump, the fixture member having a substantially planar surface and a plurality of holes therein, wherein the holes are configured to suction micro-fluid ejection modules to temporarily hold the modules in place on the fixture member for later transfer to a carrier frame to commonly mount all the modules.

35. The system of claim 34, wherein the pump is configured to selectively apply suction through the holes to hold the modules in place on the fixture member.

36. The system of claim 34, wherein a portion of the fixture member is transparent to allow the application of ultraviolet radiation through the fixture member to cure an adhesive used to mount the modules on the carrier frame.

37. The system of claim 34, wherein the fixture member includes at least one window therein configured to allow the application of ultraviolet radiation through the fixture member to cure an adhesive used to mount the modules on the carrier frame.

38. The system of claim 34, further including a plurality of spacers for mounting on the fixture member to contact the modules, wherein each spacer has a substantially planar surface and a hole therein configured to align with one of the holes in the fixture member.

39. The system of claim 38, wherein each spacer has an adhesive on a side surface to mount the spacers to the fixture member.

40. The system of claim 38, wherein each spacer has substantially the same thickness.
